(19) United States
(12) Patent Application Publication
(10) Pub. No.: US 2008/0197973 A1
(43) Pub. Date: Aug. 21, 2008

(54) Load Modulation in an Electromagnetic Transponder

(76) Inventor: Jean-Pierre Enguent, Saint Savournin (FR)

Correspondence Address: STMicroelectronics Inc.;c/o WOLF, GREENFIELD & SACKS, P.C., 600 Atlantic Avenue, BOSTON, MA, 02210-2206, US

(21) Appl. No.: 11/628,425

(22) PCT Filed: Jun. 3, 2005
(86) PCT No.: PCT/FR2005/050419

§ 371 Date: Dec. 26, 2007

(30) Foreign Application Priority Data
Jun. 3, 2004 (FR) 0451094

(51) Int. Cl. H04Q 5/22

(52) U.S. Cl. 340/10.1

(57) ABSTRACT

The invention relates to a method for modulating data (D) to be transmitted by an electromagnetic transponder (10′) by means of at least one resistive and/or capacitive element (18) for modulating the charge of an oscillating circuit that it comprises. The invention consists of combining, by an involutive function (19), the flow of data to be transmitted with a spread spectrum sequence (cᵢ(t)), said sequence being selected according to a configuration message (SRFU) received from a read/write terminal (1′).

### BACKGROUND OF THE INVENTION

1. Field of the Invention

The present invention relates to data transmission systems with electromagnetic transponders and, more specifically, to the transmission of data from a contactless and wireless electromagnetic transponder to a read/write terminal.

The electromagnetic transponders to which the present invention more specifically applies are transceivers with no autonomous power supply, which extract the power required by the electronic circuits that they comprise from an electromagnetic field radiated by the antenna of the read/write terminal. Such electromagnetic transponders are based on the use of oscillating circuits on the transponder side and on the read/write terminal side. These circuits are coupled by near electromagnetic field when the transponder enters the field of the read/write terminal.

2. Discussion of the Related Art

FIG. 1 very schematically and functionally shows a conventional example of a data exchange between a read/write terminal 1 (STA) and a transponder 10 (CAR).

Generally, terminal 1 is essentially formed of an oscillating circuit formed of an inductance L1 in series with a capacitor C1 and a resistor R1 between an output terminal 2p of an amplifier or antenna coupler 3 (CPLD) and a terminal 2m at a reference voltage (generally the ground). Amplifier 3 receives a high-frequency transmission signal Tx, originating from a modulator 4 (MOD). Modulator 4 receives a reference frequency f and, if need be, a signal DATA of data to be transmitted. In the absence of any data transmission from terminal 1 to transponder 10, signal Tx is only used as a power source to activate transponder 10 if said transponder enters the field. The data to be transmitted generally originate from a digital system, for example, a microprocessor 5 (μP). The connection point of capacitor C1 with inductance L1 forms, in the example shown in FIG. 1, a terminal for sampling a data signal Rx, received from a transponder 10, intended for a demodulator 7 (DEM). An output of demodulator 7 communicates (possibly via a decoder not shown) the received data RD to microprocessor 5. Demodulator 7 generally receives the same frequency f as demodulator 4 forming a clock or reference signal for a demodulation, generally of amplitude. The demodulation may be performed from a signal sampled across the inductance terminals and not across the capacitor. Microprocessor 5 communicates (BUS EXT) with different input/output circuits (keyboard, screen, means of transmission to a server, etc.) and/or processing circuits. Most often, but not necessarily, the read/write terminal is supplied by the electric supply system.

On the side of transponder 10, an inductance L2, in parallel with a capacitor C2, forms a parallel oscillating circuit (called a resonant receive circuit) intended to sense the magnetic field generated by series oscillating circuit L1, C1 of terminal 1. Resonant circuit L2, C2 of transponder 10 is generally tuned to the resonance frequency of oscillating circuit L1, C1 of terminal 1. Terminals 11 and 12 of resonant circuit L2, C2 are connected to two A.C. input terminals of a rectifying bridge 13 (for example, a fullwave bridge). A capacitor Ca connects rectified output terminals 14 and 15 of bridge 13 to store the power and smooth the rectified voltage provided by the bridge. When transponder 10 is in the field of terminal 1, a high-frequency voltage is generated across resonant circuit L2, C2. This voltage, rectified by bridge 13 and smoothed by capacitor CA, provides a supply voltage to electronic circuits of the transponder via a voltage regulator 16 (REG). These circuits illustrated in FIG. 1 by a block 17 (P) generally comprise a microcontroller, a demodulator of the signals possibly received from terminal 1, and a modulator for transmitting information to the terminal. The transponder is generally synchronized by means of a clock extracted from the high-frequency signal recovered across capacitor C2 before rectification (by a connection not shown). Most often, all the electronic circuits of transponder 10 are integrated in a same chip (for example, to be supported by a smart card). To transmit data from transponder 10 to the terminal, the modulator integrated to circuit 17 controls a stage 18 of modulation (back modulation) of resonant circuit L2, C2. This modulation stage is generally formed of at least one switch K (for example, a transistor) and of at least one resistor R (or capacitor) in series between terminals 14 and 15. As an alternative, stage 18 is upstream of bridge 13. Switch K is controlled at a so-called sub-carrier frequency (for example, 847.5 kilohertz), much smaller (generally with a ratio of at least 10) than the frequency of the excitation signal of the oscillating circuit of terminal 1 (for example, 13.56 megahertz). When switch K is on, the transponder's oscillating circuit is submitted to an additional damping with respect to the load formed by circuits 16 and 17, so that the transponder samples a more significant amount of power from the high-frequency magnetic field. On the side of terminal 1, amplifier 3 maintains the amplitude of the high-frequency excitation signal constant. Accordingly, the power variation of the transponder translates as an amplitude and current phase variation in antenna L1. This variation is detected by demodulator 7 of terminal 1. Demodulator 7 restores a signal RD which is an image of the control signal of switch K which can be decoded to restore the transmitted binary data.

FIG. 2 illustrates a conventional example of a data transmission from terminal 1 to a transponder 10 such as provided by standard ISO 14443. FIG. 2 shows an example of the shape of the excitation signal I of antenna L1 for a transmission of a code 0101. The modulation currently used is an amplitude modulation with a 106-kilobit-per-second rate (1 bit is transmitted in approximately 9.4 microseconds) much smaller than the frequency (13.56 MHz) of carrier f (period of approximately 74 nanoseconds). The amplitude modulation is performed, for example, with a modulation rate (defined as being the difference of the peaks amplitudes between the two states 0 and 1, divided by the sum of these amplitudes (a−b/a+b)) smaller than 100% due to the need for supply of transponder 10. In the example of FIG. 2, the transmission of a bit from terminal 1 to transponder 10 requires 128 halfwaves of the carrier.

FIGS. 3A, 3B, and 3C illustrate a conventional example of a data transmission from transponder 10 to terminal 1. FIG. 3A illustrates an example of a code 010 generated by circuit 17 and which is to be transmitted to the terminal. FIG. 3B illustrates the corresponding shape of control signal x(t) of back-modulation switch K. FIG. 3C illustrates the corresponding shape of signal Rx received by demodulator 7 of the terminal. In FIG. 3C, signal Rx has been shown as smoothed, that is, without showing the ripple of the 13.56-megahertz high-frequency carrier. Further, for simplification, no account has been taken of the time offset linked to the transmission. On the transponder side, the back modulation is of resistive or capacitive type with a 847.5-kHz sub-carrier (period of approximately 1.18 microsecond). This back modulation is for example based on a coding of BPSK (Binary Phase Shift Keying) type at a rate on the order of 106 kilobits per second, much smaller than the sub-carrier frequency. Whatever the type of modulation used (for example, amplitude, phase, or frequency modulation) and whatever the type of data coding (NRZ, NRZI, Manchester, ASK, BPSK, etc.), the back modulation is performed digitally, by shift between two binary states. As illustrated in FIG. 3B, signal x(t) is formed of a pulse train at the sub-carrier frequency, a phase inversion occurring for each passing from one bit to the next bit, since it is each time a state switching. This phase shift is reflected in the received signal Rx and enables the terminal to recover the transmitted code.

The transmission from the transponder to the terminal poses a specific problem in terms of noise. Indeed, the different transponder components and especially a charge pump circuit comprised by regulator 16 often generate a switching noise which is at a frequency close to the sub-carrier frequency. In such a case, the resultant of signal x(t) in the resonant circuit is polluted by noise, which makes its decoding by the terminal more difficult.

### SUMMARY OF THE INVENTION

The present invention aims at solving this and other problems by providing a novel (back-)modulation method of the load of a transponder to transmit data to a read/write terminal.

The present invention also aims at providing a solution which is compatible with conventional back-modulation (resistive or capacitive) circuits.

The present invention also aims at providing a solution requiring no structural (hardware) modification of the transponder circuits.

To achieve these and other objects, the present invention provides a method for modulating data to be transmitted by an electromagnetic transponder by means of at least one resistive and/or capacitive element of modulation of the load of an oscillating circuit that it comprises, including combining, by an involutional function, the data flow to be transmitted with a spectrum spreading sequence, said sequence being selected according to a configuration message received from a read/write terminal.

According to an embodiment of the present invention, said function is an XOR.

According to an embodiment of the present invention, said spreading sequence is selected from a set of sequences all having the feature of having an average frequency in the operating range of a demodulator comprised by the terminal.

According to an embodiment of the present invention, the frequency of a remote-supply carrier from the terminal to the transponder is used as a clock for generating the spreading sequence.

According to an embodiment of the present invention, said configuration message is transmitted in a request frame transmitted in a loop by the read/write terminal.

According to an embodiment of the present invention, a transponder receiving said request responds in a frame by using a spreading sequence selected according to said binary message received from the terminal.

According to an embodiment of the present invention, the terminal stores a plurality of responses performed with different spreading sequences and sends a last request with a configuration message corresponding to the response received with the best quality.

According to an embodiment of the present invention, the spreading sequence forms a key for ciphering the transmitted data.

The present invention also provides a method for demodulating a signal received from an electromagnetic transponder comprises combining the signal, by a same function, with the same spreading sequence as that having been used for the transmission.

The present invention also provides an electromagnetic transponder comprising:

an oscillating circuit;

an electronic circuit comprising a transmit circuit for transmitting digitally-coded data;

at least one resistive and/or capacitive modulation circuit coupled to the oscillating circuit; and

means for implementing the method of the present invention.

The present invention also provides a terminal of communication with an electromagnetic transponder, comprising:

an oscillating circuit;

an electronic circuit comprising a transmit circuit for transmitting digitally-coded data;

a modulation circuit coupled with the oscillating circuit;

a demodulator of a signal sampled from the oscillating circuit; and

means for implementing the method of the present invention.

### BRIEF DESCRIPTION OF THE DRAWINGS

The foregoing objects, features, and advantages of the present invention will be discussed in detail in the following non-limiting description of specific embodiments in connection with the accompanying drawings, in which:

FIG. 1, previously described, shows an example of a transmit system to which the present invention applies;

FIG. 2, previously described, illustrates a conventional example of a data transmission in the terminal-to-transponder direction;

FIGS. 3A, 3B, and 3C, previously described, illustrate a conventional example of the data transmission in the transponder-to-terminal direction;

FIG. 4 partially and schematically shows an embodiment of the transmission method according to the present invention;

FIGS. 5A, 5B, 5C, and 5D show a first example of a transmission of a code 0110 by implementation of the present invention;

FIGS. 6A, 6B, 6C, and 6D illustrate a second example of transmission of the same code 0110 by implementation of the present invention;

FIG. 7 very schematically shows in simplified fashion, a system of communication between a terminal and a transponder according to a preferred embodiment of the present invention;

FIG. 8 illustrates the structure of an example of a query frame from a terminal intended for a transponder likely to be present in its field;

FIG. 9 illustrates the structure of a word of the frame of FIG. 8; and

FIG. 10 illustrates the structure of an example of a response frame of a transponder according to an embodiment of the present invention.

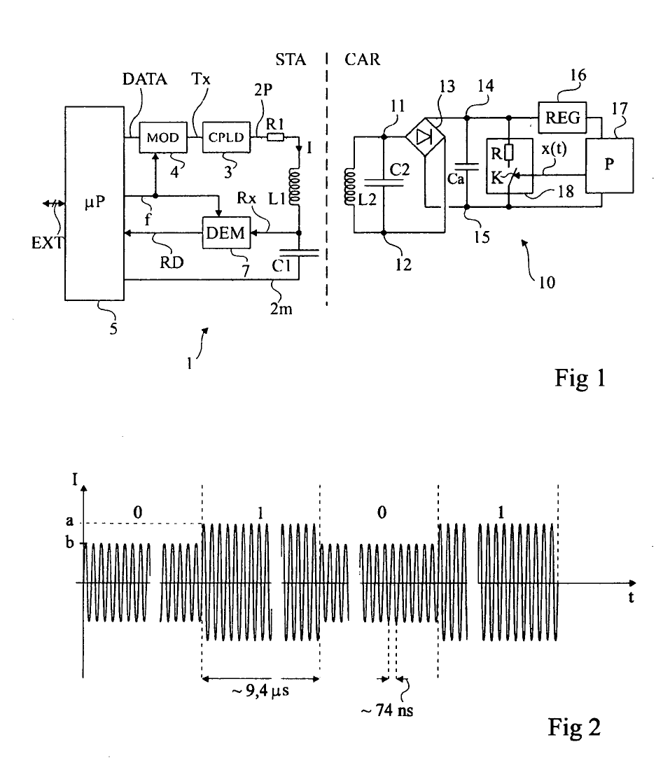

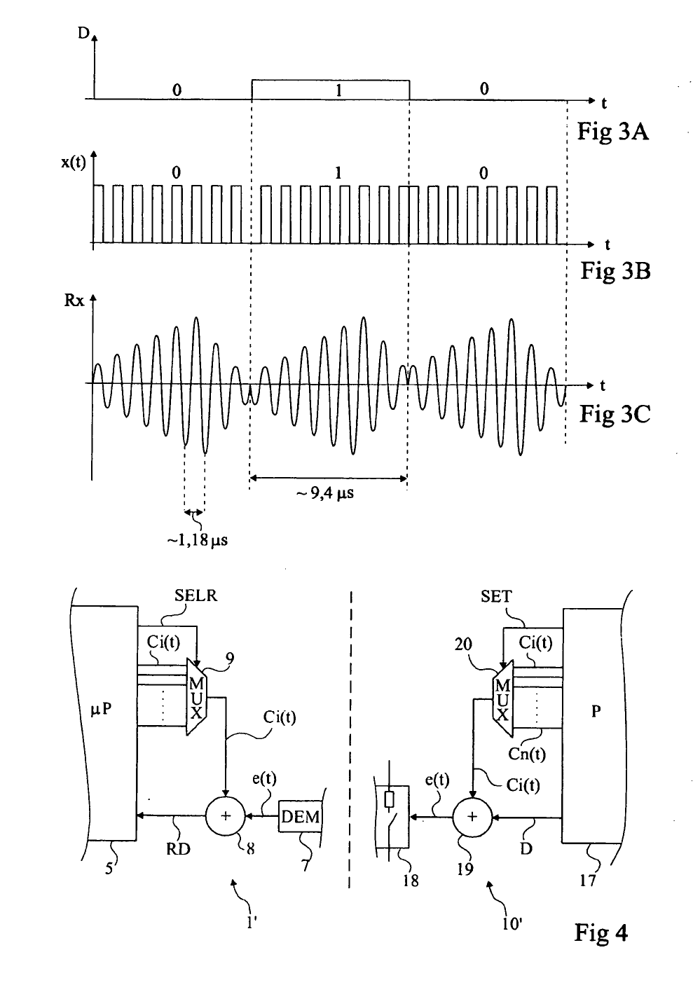

### DETAILED DESCRIPTION

The same elements have been designated with the same reference numerals in the different drawings, which have been drawn out of scale. For clarity, only those elements and steps that are necessary to the understanding of the present invention have been shown in the drawings and will be described hereafter. In particular, the circuits for generating and exploiting the transmitted binary data have not been described in detail, the present invention being implementable with conventional structures.

A feature of the present invention is to modulate a digital signal of binary data to be transmitted (possibly after coding) by means of a spread spectrum frequency. According to the present invention, this spreading sequence is selected from among a set of available sequences for its qualities in terms of absence of noise in the transmission.

The use of spreading sequences is known for multiple transmissions. In such applications, spectrum spreading sequences are used to differentiate the different transmissions using a same support (for example, in telephony). Most often, these spreading sequences are randomly selected at the beginning of each transmission. When a problem is posed in one of these multipath communications, the transmit power is increased but the spreading sequence is not changed.

Conversely, the present invention provides in a single-path application, that is, in a communication from a transponder to a terminal, selecting a spreading sequence from among a set of predetermined sequences (no random selection) according to its noise characteristics.

Another feature of the present invention is to adapt the used spreading sequence to the real-time operating conditions of the system. For this purpose, the present invention takes advantage from the structure of the exchanges between a terminal and a transponder in which a terminal periodically transmits an interrogation frame until a transponder responds. Thus, the present invention preferentially provides, using this frame to send to the transponders that may be in the field, the bits of configuration of their back-modulation circuits, to select a spreading sequence and to change this selection if the received data are not correctly exploitable by the terminal.

FIG. 4 partially and very schematically shows an embodiment of a read/write terminal 1′ and of a transponder 10′ adapted for the implementation of the method of the present invention. For simplification, only processor 5 (μP) and demodulator 7 (DEM) have been shown on the side of terminal 1′, the rest of the components being similar to the conventional case (FIG. 1). Similarly, on the side of transponder 10′, only block 17 representing the processing circuits and block 18 representing the back modulation stage have been shown.

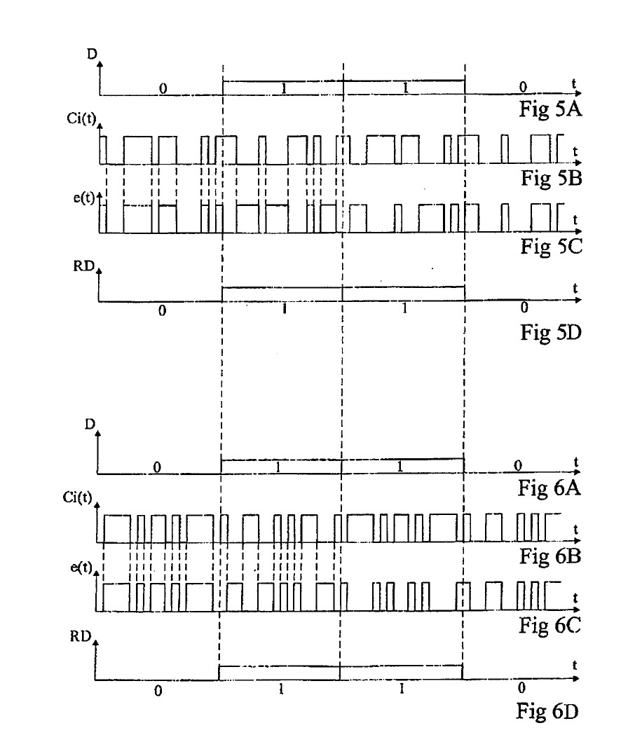

FIG. 4 will be described in relation with FIGS. 5A, 5B, 5C, 5E and 6A, 6B, 6C, and 6E which illustrate, in timing diagrams showing characteristic signals at points of FIG. 4 for two different spreading sequences, the operation of the present invention.

As previously, circuits 17 of the transponder generate a flow D of binary data to be transmitted to a terminal. Whether these data have or not been previously coded is of no importance.

According to the present invention, flow D (FIG. 5A or FIG. 6A) is combined for example by an XOR-type function 19 with a spreading sequence cᵢ(t). Two examples of different spreading sequences cᵢ(t) are shown in FIGS. 5B and 6B. The result of the combination forms signal e(t) of control of back-modulation stage 18. In other words, signal e(t) of the present invention replaces signal x(t) of the conventional transponder of FIG. 1. FIGS. 5C and 6C show the respective shapes of signals e(t) for the respective spreading sequences of FIGS. 5B and 6B.

On the side of read/write terminal 1′, demodulator 7 restores signal e(t). This signal is combined again (block 8) by a function of the same type (for example, XOR) with the same spectrum spreading sequence cᵢ(t) also contained in terminal 1′, for example, in a memory. Block 8 provides signal RD (FIGS. 5D and 6D) to data exploitation circuit 5.

A combination by an XOR function is a preferred embodiment for its simplicity of implementation. However, any other involutional function (function f such that, for any couple (x,y), f(f(x,y))=(x,y)) may be selected, what matters being to be able to recover, on the terminal side, the transmitted data by using the same spectrum spreading sequence as that used for the transmission.

Functionally, the selection of spreading sequence cᵢ(t) is performed, on the side of transponder 10′, for example, by a multiplexer 20 and, on the terminal side, by a multiplexer 9. Multiplexers 20 and 9 are respectively controlled by selection signals SELT and SELR provided by the respective internal 17 and 5. Multiplexers 20 and 9 receive n spreading sequences C₁(t), . . . , Cₙ(t). Of course, to be able to demodulate, the spreading sequence Cᵢ(t) selected by the terminal (signal SELR) must be the same as that selected by the transponder for the transmission (signal SELT).

As appears from the timing diagrams of FIGS. 5 and 6, the transmission of a same data flow 0110 with two different spreading sequences (FIGS. 5B and 6B) enables the terminal to recover data flow RD, provided to use the same spreading sequence for the decoding (block 8).

According to the present invention, the n spreading sequences are generated by respecting an average frequency in the operating range of demodulator 7 of the terminal. This avoids modification of the demodulator despite the use of different spreading sequences. Referring to the example of ISO terminal 14443, the spreading sequences will preferentially all be comprised within average frequencies from 600 to 1000 kHz, to remain close to the 847.5 kHz frequency exploitable by demodulator 7.

The spreading sequence generation preferentially uses frequency f of the carrier generated by the terminal. This frequency is indeed available on the terminal side and on the transponder side and its ratio of at least 10 with the sub-carrier frequency enables generation of spreading sequences different from one another. In the example of the drawings, the length (pattern repetition frequency) of the spreading sequences cᵢ(t) arbitrarily corresponds to the duration of two bits to be transmitted. However, the respective lengths of the spreading sequences are of no importance, they may be different from one sequence to another and correspond or not to multiples of the 847.5-kHz frequency. The only constraint is the frequency used to generate the sequence (for example, 13.56 MHz), which must be compatible with the clock frequency usable by the circuits of the transponder and of the terminal, and which conditions the minimum width of a pulse of the sequence and the minimum interval between two pulses.

Number n of available spreading sequences depends on the respective capacitances of the transponder and of the terminal. For example, in a preferred embodiment, it will be selected from among a set of from eight to thirty-two spreading sequences.

The different spreading sequences usable by a given system may have been generated in advance and be stored in memories of the transponder and of the terminal or be generated in real time, on the fly. What matters is that for a given identifier of a spreading sequence, a transponder and a terminal capable of communicating together use the same spreading sequence. The generation of the spreading sequences uses techniques conventional per se, especially as concerns the length of the sequences. In particular, the actual generation (not the selection) may use pseudo-random techniques (respecting the average frequencies accepted by the demodulator).

An advantage of the present invention is that it enables minimizing the effects of noise on the transmission in the transponder-to-terminal direction. Even if the selected sequence does not suppress any noise, the implementation of the present invention enables selecting that providing a transmission quality considered as acceptable or the best one from among the available qualities. Conversely to applications where the transmission power is increased, the present invention applies to a field (remotely supplied electromagnetic transponder) where the power is limited and cannot be increased.

Another advantage of the present invention is that the spreading sequence may also be used as a transmission ciphering key. Thus, the data piracy between a transponder and a terminal is made more difficult.

The selection of the code or spreading sequence for a given transmission may take different forms. According to a first example, all the available spread codes are surveyed (for example, successively in the order) and the terminal selects that providing the best transmission level. The terminal then transmits to the transponder an identifier of this spreading sequence to enable it to configure its signal SELT. According to another example, the terminal selects, on surveying the spreading sequences one after another, the first one which provides an acceptable receive level.

Preferably, the spreading sequence is selected at the beginning of a transmission. The present invention then takes advantage from the fact that, in electromagnetic transponder transmission systems, terminal interrogation phases are periodically reproduced. These phases are then used by the present invention to configure the spreading sequence.

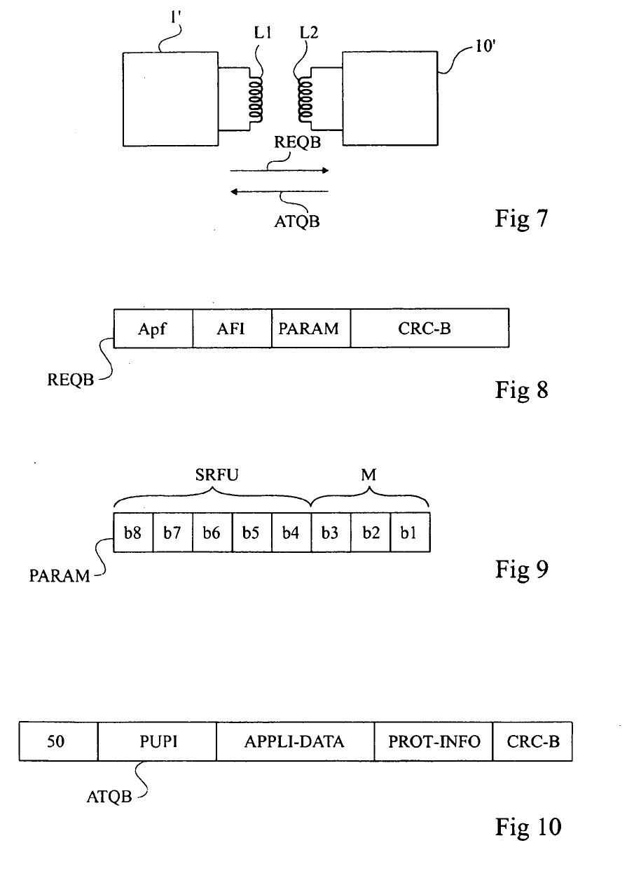

FIG. 7 very schematically shows a read/write terminal 1′ and its antenna L1, and a transponder 10′ according to the present invention and its antenna L2. Conventionally, a terminal 1′ monitors the presence of a transponder 10′ in the field radiated by its antenna L1 by periodically sending a frame REQB likely to be sensed by a transponder when it is present in the field. As soon as a transponder senses and decodes a frame REQB transmitted by a terminal, it responds with an acknowledgement frame ATQB. This response is performed by switching the load added on the oscillating circuit, in conventional systems, at the rate of the back-modulation sub-carrier. According to the present invention, this switching is performed at the rate of the selected spreading sequence as will be seen hereafter.

According to ISO standard 14443, frames REQB and ATQB have specific formats. It should however be noted that the present invention is not limited to these frames and may be implemented as soon as a terminal periodically sends query messages to transponders possibly present in its field and that a transponder, as soon as it is present, responds with a specific message. Further, the present invention is compatible with systems where the same terminal may communicate with several transponders.

FIG. 8 illustrates the structure of a frame REQB according to ISO standard 14443 taken as an example. This frame first comprises a byte Apf (Anticollision Prefix Byte) forming an anticollision prefix. Byte Apf is followed by a byte AFI (Application Family Identifier) which represents the type of application(s) aimed at by the terminal and which is used to select a transponder likely to respond to a given frame REQB. Byte AFI is followed by an anticollision parameterizing byte PARAM, itself followed by two bytes CRC-B containing a calculation performed on the previous bytes, enabling detecting communication errors.

In this example, the present invention preferably uses bits of byte PARAM to transmit an order of selection of the spreading sequence of any transponder present in the terminal's field. Indeed, as illustrated in FIG. 9 which represents the structure of a byte PARAM according to ISO standard 14443, the first three bits B1, B2, B3 are used to set an anticollision parameter M while the other five bits B5, B6, B7, and B8 are free (SRFU). Thus, the present invention provides preferentially using these five bits to transmit a code to a transponder to set the spreading sequence desired for it. Five available bits represent 32 possible selections, which is widely enough (32 spreading sequences).

The transponder receiving a frame REQB interprets bits B4 to B8 of word PARAM as orders different from the spreading sequence to be selected. Whether a given transponder is not able to select all combinations of bits B4 to B8 matters little, in particular if it does not have the same number of available spreading sequences for memory bulk reasons. What matters is that, for a given code, said code selects the same spreading sequence as the terminal.

When a transponder decodes a frame REQB, it responds thereto by a frame ATQB. A frame ATQB according to ISO standard 14443 comprises 14 bytes.

FIG. 10 shows an example of the content of a frame ATQB. A first byte contains a fixed value (for example, number 50). The next three bytes contain an identifier PUPI (Pseudo Unique PICC Identifier) of the transponder. The next four bytes (APPLI-DATA) identify the type of application(s) contained in the transponder. The next three bytes (PROT-INFO) contain information about the communication protocol, and the last two bytes CRC-B contain the CRC calculation.

This response ATQB is, according to the present invention, performed by using a specific spreading sequence which is a function of the combination set by bits B4 and B8 of word PARAM. When the reader (terminal 1′) receives message ATQB and decodes it, it is able to determine whether the message that it receives is of sufficient quality and, especially, if it is too noisy.

According to a first embodiment, a threshold is used on the terminal side to determine whether the receive quality is or not satisfactory. In this case, the different combinations of configuration bits B4 to B8 are successively sent into frames REQB and, as soon as a frame ATQB is received with a sufficient quality, it is passed on to the rest of the communication without transmitting the other frames REQB. The spreading sequence having been used for the sending of this last frame ATQB remains used by transponder 10′ until occurrence of a new frame REQB.

According to another embodiment, frame REQB is sent in a loop by using all possibilities and by storing the levels received by the respective response frames ATQB. Once the best spreading sequence has been determined by the terminal, said terminal uses again word PARAM in a last request REQB to set the sequence desired for the transponder. On the transponder side, said transponder keeps the configuration set by frame REQB until the next frame REQB, that is, until the next transmission.

A survey of the different possibilities is perfectly compatible with the transmission rates. Indeed, the usual duration of a request REQB is on the order of 380 microseconds and the usual duration of a response ATQB is on the order of one millisecond, which is negligible with respect to the displacement speed of a transponder in front of the terminal which is of several hundreds of milliseconds (displacement speed of a hand holding the smart card, for example). The usual duration of a transmission between a terminal and a transponder before restarting requests REQB generally is on the order of several tens of milliseconds, which is here again perfectly compatible with the duration required to set, by the implementation of the present invention, the spreading sequence used in the back modulation.

An advantage of the present invention is that it enables optimizing the quality of reception by the terminal, whatever the possible disturbances present and especially the noise generated by the transponder itself.

Another advantage of-the present invention is that it enables dynamic adaptation, that is, adaptation on each exchange between a transponder and a terminal.

Another advantage of the present invention is that it does not require modifying the structure of conventional terminals. It is enough, for standard 14443, to provide specific bits B4 to B8 in frame REQB transmitted in a loop by the terminal. Afterwards, the exploitation of the data received by the demodulator being generally performed in a software manner, the implementation of the present invention by an XOR combination with the spreading sequence only requires a software modification and no structural modification. As an alternative, for a hardware implementation of the present invention, a single XOR gate and a multiplexer are sufficient. Similarly, the present invention requires no structural modification of existing transponders, the present invention may be implemented in exclusively software manner on the transponder side by having generate, by the microprocessor thereof, directly sequence e(t) combining the selected spreading sequence with the data to be transmitted.

Of course, the present invention is likely to have various alterations, modifications, and improvements which will readily occur to those skilled in the art. In particular, although the present invention has been described in relation with a preferred embodiment adapted to ISO standard 14443, it may be provided to modify a frame of loop transmission by a terminal to adapt to other transmission systems. Further, the practical forming of the present invention by hardware and/or software means is within the abilities of those skilled in the art based on the functional indications given hereabove. Further, the generation of adapted spreading sequences and especially the determination of their respective lengths is within the abilities of those skilled in the art by using conventional methods for generating such spreading sequences.

Such alterations, modifications, and improvements are intended to be within the scope of the invention. Accordingly, the foregoing description is by way of example only and is not intended as limiting. The invention is limited only as defined in the following claims and the equivalents thereto.

What is claimed is:

1. A method for modulating data to be transmitted by an electromagnetic transponder by means of at least one resistive and/or capacitive element of modulation of the load of an oscillating circuit that it comprises including combining, by an involutional function, the data flow to be transmitted with a spectrum spreading sequence, said sequence being selected according to a configuration message received from a read/write terminal.

2. The method of claim 1, wherein said function is an XOR.

3. The method of claim 1, wherein said spreading sequence is selected from a set of sequences all having the feature of having an average frequency in the operating range of a demodulator comprised by the terminal.

4. The method of claim 1, wherein the frequency of a remote-supply carrier from the terminal to the transponder is used as a clock for generating the spreading sequenced.

5. The method claim 1, wherein said configuration message is transmitted in a request frame transmitted in a loop by the read/write terminal.

6. The method of claim 5, wherein a transponder receiving said request responds in a frame by using a spreading sequence (cᵢ(t)) selected according to said binary message received from the terminal.

7. The method of claim 6, wherein the terminal stores a plurality of responses performed with different spreading sequences and sends a last request with a configuration message corresponding to the response received with the best quality.

8. The method of claim 1, wherein the spreading sequence forms a key for ciphering the transmitted data.

9. A method for demodulating a signal received from an electromagnetic transponder and containing data modulated by the method of claim 1, comprising combining the signal, by a same function, with the same spreading sequence as that having been used for the transmission.

10. An electromagnetic transponder comprising:
an oscillating circuit;
an electronic circuit comprising a transmit circuit for transmitting digitally-coded data;
at least one resistive and/or capacitive modulation circuit coupled to the oscillating circuit; and
means for combining, by an electromagnetic transponder by means of at least one resistive and/or capacitive element of modulation of the load of an oscillating circuit that it comprises combining, by an involutional function, the data flow to be transmitted with a spectrum spreading sequence, said sequence being selected according to a configuration message received from a read/write terminal

11. A terminal of communication with an electromagnetic transponder comprising:
an oscillating circuit;
an electronic circuit comprising a transmit circuit for transmitting digitally-coded data;
a modulation circuit coupled with the oscillating circuit;
a demodulator of a signal sampled from the oscillating circuit; and means for implementing the method of
means for combining, by an electromagnetic transponder by means of at least one resistive and/or capacitive element of modulation of the load of an oscillating circuit that it comprises combining, by an involutional function, the data flow to be transmitted with a spectrum spreading sequence, said sequence being selected according to a configuration message received from a read/write terminal.
